(19) United States
(12) Patent Application Publication
(10) Pub. No.: US 2008/0226845 A1
(43) Pub. Date: Sep. 18, 2008

(54) Polyamic acid-based composition and liquid crystal orienting film

(75) Inventors: Chuan-Ter Yan, Kaohsiung City (TW); Chih-Hsiung Huang, Kaohsiung City (TW); Chao-Ching Huang, Kaohsiung City (TW); Chin-Wang Kao, Kaohsiung Hsien (TW); Tin-Hun Hung, Kaohsiung City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: DAILY POLYMER CO., LTD.

(21) Appl. No.: 11/723,120

(22) Filed: Mar. 16, 2007

(51) Int. Cl. C09K 19/00

(52) U.S. Cl. 428/1.25; 525/432

(57) ABSTRACT

A polyamic acid-based composition includes: a polyamic acid A prepared by a process including reacting an aromatic tetracarboxylic dianhydride and an aromatic diamine; and a polyamic acid B prepared by a process including reacting an aliphatic tetracarboxylic dianhydride, an aromatic diamine having a side chain, and a non-aromatic diamine. A liquid crystal orienting film is formed by a process including: preparing a mixture containing the aforesaid polyamic acid-based composition and a solvent; coating the mixture onto a substrate so as to form a film on the substrate; and heating the film so as to convert polyamic acid of the polyamic acid-based composition into polyamide.

### BACKGROUND OF THE INVENTION

1. Field of the Invention

This invention relates to a polyamic acid-based composition and a liquid crystal orienting film formed from the polyamic acid-based composition.

2. Description of the Related Art

Because of lightweight and low power consumption characteristics of a liquid crystal display, a miniature portable personal information device with a liquid crystal display panel has been widely developed. However, since a miniature device normally cannot be used under a high driving voltage, a liquid crystal display requiring lower driving voltage and having improved properties has been demanded. The properties required to be improved include the pre-tilt angle, electrical properties such as current consumption, voltage holding ratio (VHR), and residual voltage, and the reliability of the aforesaid properties in long-term use.

In general, the required pre-tilt angle for liquid crystal is changed based on the driving system of the liquid crystal display. For example, a twisted nematic (TN) liquid crystal display (twisted by 90°) requires a pre-tilt angle of 1 to 6°, and a super twisted nematic (STN) liquid crystal display (twisted by 180° or more) requires a pre-tilt angle of 3 to 8°. In a TFT liquid crystal display, high voltage holding ratio (99%) is required, but requirement for liquid crystal orientation is low. However, in a STN liquid crystal display, an 80% voltage holding ratio is sufficient, but requirement for liquid crystal orientation is high. That is, undesired domains that adversely affect the orienting property of the liquid crystal material should be minimized in the STN liquid crystal display.

To meet the aforesaid demands, researches have been focused on the modification of constituents of a liquid crystal orienting film. For example, Chisso Corporation of Japan has proposed polyamic acid-based compositions disclosed in, for example, U.S. Pat. No. 6,620,339 B1 and U.S. Pat. No. 6,946,169 B1.

U.S. Pat. No. 6,620,339 B1 discloses a polyamic acid composition including a polyamic acid A providing a polyimide resin giving a residual voltage of 200 mV or less and a voltage holding ratio of 97% or higher, and a polyamic acid B providing a polyimide resin giving a pre-tilt angle of 3-15°. The weight ratio of the polyimide resin of the polyamic acid A to the polyimide resin of the polyamic acid B ranges from 50/50 to 95/5. The polyamic acid A includes an alicyclic tetracarboxylic dianhydride as an acid component and an aromatic diamine represented by the following formula (1) as a diamine component,

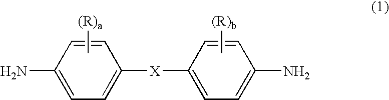

wherein X is a divalent aliphatic group, each R is independently a hydrogen atom or CH₃, and a and b are 1 to 2. The polyamic acid B includes 50 mole % or more aromatic tetracarboxylic dianhydride as an acid component and a diamine having a group capable of increasing the pre-tilt angle of a liquid crystal on the side chain thereof. The diamine having a group on the side chain thereof can be the diamines having the formulas (2) and (3).

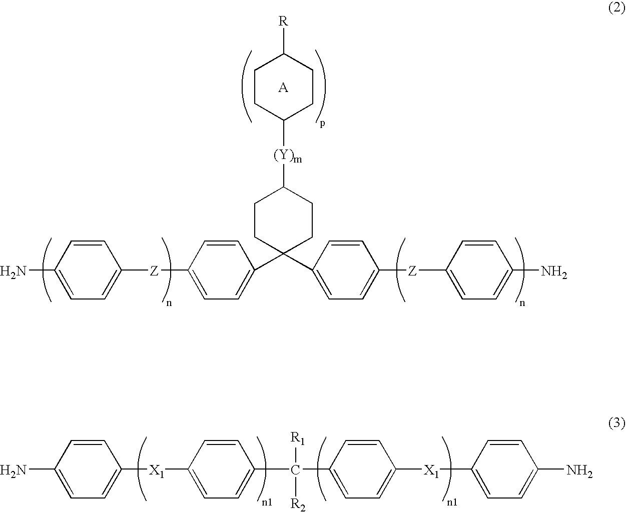

In formula (2), R is hydrogen atom or an alkyl group having 1 to 12 carbon atoms, Y is a CH₂ group, m is an integer from 0 to 2, A is a benzene ring or a cyclohexane ring, p is 0 or 1, Z is an oxygen atom or a CH₂ group, and n is 0 or 1. In formula (3), X₁ is a CH₂ group or an oxygen atom, R₁ and R₂ are individually a hydrogen atom, an alkyl group or a perfluoroalkyl group having 1 to 12 carbon atoms, at least one of the R₁ and R₂ is an alkyl group or a perfluoroalkyl group having 3 or more carbon atoms, and n1 is 0 or 1. An orienting film made from the aforesaid polyamine acid composition has a pre-tilt angle ranging from 5 to 9° and a voltage holding ratio ranging from 97% to 98.4%.

Although the patent provides a liquid crystal orienting film suitable for a liquid crystal display having an optimal pre-tilt angle and an improved voltage holding ratio, the issue of orienting property of the liquid crystal is not addressed in this patent. Furthermore, according to the industry requirements, the voltage holding ratio is preferably greater than 99%.

Therefore, there is a need in the art to provide a polyamic acid-based composition that can provide improved orienting property, while maintaining a desired voltage holding ratio and pre-tilt angle for the liquid crystal display.

### SUMMARY OF THE INVENTION

According to one aspect of this invention, a polyamic acid-based composition includes: a polyamic acid A prepared by a process including reacting an aromatic tetracarboxylic dianhydride and an aromatic diamine; and a polyamic acid B prepared by a process including reacting an aliphatic tetracarboxylic dianhydride, an aromatic diamine having a side chain, and a non-aromatic diamine.

According to another aspect of this invention, a liquid crystal orienting film is formed by a process including: preparing a mixture containing the aforesaid polyamic acid-based composition and a solvent; coating the mixture onto a substrate so as to form a film on the substrate; and heating the film so as to convert polyamic acid of the polyamic acid-based composition into polyamide.

### DETAILED DESCRIPTION OF THE PREFERRED EMBODIMENTS

A polyamic acid-based composition according to this invention includes a polyamic acid A and a polyamic acid B. The polyamic acid A is prepared by a process including reacting an aromatic tetracarboxylic dianhydride and an aromatic diamine. The polyamic acid B is prepared by a process including reacting an aliphatic tetracarboxylic dianhydride, an aromatic diamine having a side chain, and a non-aromatic diamine.

The aromatic reactants (i.e., tetracarboxylic dianhydride and the aromatic diamine) constituting the polyamic acid A serve to provide proper orienting property for the liquid crystal because of good compatibility with the liquid crystal having aromatic groups (e.g., benzene ring), and improved rubbing resistance. The aromatic diamine having a side chain contained in the polyamic acid B serves to provide proper pre-tilt angle, while the aliphatic tetracarboxylic dianhydride and the non-aromatic diamine contribute to proper electrical properties, e.g., higher voltage holding ratio.

As described above, since the polyamic acid A and polyamic acid B provide different properties, the ratio thereof can vary based on actual requirements and the liquid crystal materials to be used therewith. Preferably, the ratio of the polyamic acid A to the polyamic acid B ranges from 75:25 to 30:70, more preferably, from70:30 to 50:50.

Similarly, the molar ratio of the aromatic diamine having a side chain to the non-aromatic diamine of the polyamic acid B can vary based on actual requirements and the liquid crystal materials to be used therewith. Preferably, the molar ratio of the aromatic diamine having a side chain to the non-aromatic diamine of the polyamic acid B ranges from 70:30 to 1:99, more preferably, from 45:55 to 3:97. In an example of this invention, the molar ratio of the aromatic diamine having a side chain to the non-aromatic diamine of the polyamic acid B is 6:94.

The aromatic tetracarboxylic dianhydride of the polyamic acid A can be any aromatic tetracarboxylic dianhydride. Preferably, the aromatic tetracarboxylic dianhydride of the polyamic acid A is selected from the group consisting of pyromellitic dianhydride (PMDA), biphenyl tetracarboxylic dianhydride (BPDA), 1,4,5,8-naphthalenetetracarboxylic dianhydride, 2,3,6,7-naphthalenetetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furanetetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, bis(phthalic acid)phenylphosphine oxide dianhydride, p-phenylene-bis(triphenylphthalic)dianhydride, m-phenylene-bis(triphenylphthalic)dianhydride, bis(triphenylphthalic acid)-4-4′-diphenylether dianhydride, bis(triphenylphthalic acid)-4-4′-diphenylmethane dianhydride, and mixtures thereof. In an example of this invention, the aromatic tetracarboxylic dianhydride is PMDA.

The aromatic diamine of the polyamic acid A can be any aromatic diamine. Preferably, the aromatic diamine of the polyamic acid A is selected from the group consisting of 2,2-bis[4-(4-aminophenoxy)phenyl]hexafluoropropane (HFBAPP), 2,2-bis(4-aminophenoxy)hexafluoropropane, 2,2′-bis[4-(4-amino-2-trifluoromethylphenoxy)phenyl]hexafluoropropane, 4,4′-diamino-2,2′-bis(trifluoromethyl)biphenyl, 4,4′-bis[(4-amino-2-trifluoromethyl)phenoxy]octafluorobiphenyl, 4,4′-bis[(4-aminophenoxy)biphenyl (BAPB), p-phenylenediamine, m-phenylenediamine, 4,4′-diamino-3,3′-dicarboxydiphenylmethane, 1,4-bis(4-aminophenyl)benzene, 4,4′-diaminophenyl, 3,3′-dimethyl-4,4′-diaminobiphenyl, 3,3′-dimethoxy-4,4′-diaminobiphenyl, 3,3′-dihydroxy-4,4′-diaminobiphenyl, 3,3′-dichloro-4,4′-diaminobiphenyl, 3,3′-diamino-4,4′-diaminobiphenyl, diaminodiphenylmethane, diaminodiphenyl ether, 2,2′-diaminodiphenylpropane, 4,4′-diaminodiphenylsulfone, diaminobenzophenone, 1,3-bis(4-aminophenoxy)benzene, 1,4-bis(4-aminophenoxy)benzene, 4,4′-di(aminophenoxy)diphenylsulfone, 2,2′-bis[4-(4-aminophenoxy)phenyl]propane, and mixtures thereof. In an example of this invention, the aromatic diamine is BAPB.

The aliphatic tetracarboxylic dianhydride of the polyamic acid B can be any aliphatic tetracarboxylic dianhydride. Preferably, the aliphatic tetracarboxylic dianhydride of the polyamic acid B is selected from the group consisting of bicyclo(2,2,2)oct-7-ene-2,3,5,6-tetracarboxylic dianhydride (BCDA), 1,2,3,4-butanetetracarboxylic dianhydride (BDA), 3,4-dicarboxy-1,2,3,4-tetrahydro-1-naphthalene succinicanhydride (TDA), 2,3,5-tricarboxycyclopentylacetic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 3,5,6-tricarboxynorbornane-2-acetic dianhydride, 2,3,4,5-tetrahydrofurantetracarboxylic dianhydride, and mixtures thereof. In an example of this invention, the aliphatic tetracarboxylic dianhydride is BDA.

The aromatic diamine having a side chain of the polyamic acid B can be any aromatic diamine having a side chain. Preferably, the aromatic diamine having a side chain is selected from the group consisting of a diamine expressed by formula (I), 1,1-bis[4-(4-aminophenoxy)phenyl]-4-(cyclohexylmethyl)cyclohexane, 1,1-bis[4-(4-aminophenoxy)phenyl]-4-[(4-methylcyclohexyl)methyl]cyclohexane, 1,1-bis[4-(4-aminophenoxy)phenyl]-4-[(4-ethylcyclohexyl)methyl]cyclohexane, 1,1-bis[4-(4-aminophenoxy)phenyl]-4-[(4-propylcyclohexyl)methyl]cyclohexane, 1,1-bis[4-(4-aminophenoxy)phenyl]-4-[(4-butylcyclohexyl)methyl]ycyclohexane, 1,1-bis[4-(4-aminophenoxy)phenyl]-4-[(4-pentylcyclohexyl)methyl]cyclohexane, 1,1-bis[4-(4-aminophenoxy)phenyl]-4-[(4-hexylcyclohexyl)methyl]cyclohexane, 1,1-bis[4-(4-aminophenoxy)phenyl]-4-[(4-heptylcyclohexyl)methyl]cyclohexane, 1,1-bis[4-(4-aminophenoxy)phenyl]-4-[(4-octylcyclohexyl)methyl]cyclohexane, 1,1-bis(4-aminophenyl)-4-(cyclohexylmethyl)cyclohexane, 1,1-bis(4-aminophenyl)-4-[(4-methylcyclohexyl)methyl]cyclohexane, 1,1-bis(4-aminophenyl)-4-[(4-ethylcyclohexyl)methyl]cyclohexane, 1,1-bis(4-aminophenyl)-4-[(4-propylcyclohexyl)methyl]cyclohexane, 1,1-bis(4-aminophenyl)-4-[(4-butylcyclohexyl)methyl]cyclohexane, 1,1-bis(4-aminophenyl)-4-[(4-pentylcyclohexyl)methyl]cyclohexane, 1,1-bis(4-aminophenyl)-4-[(4-hexylcyclohexyl)methyl]cyclohexane, 1,1-bis(4-aminophenyl)-4-[(4-heptylcyclohexyl)methyl]cyclohexane, 1,1-bis(4-aminophenyl)-4-[(4-octylcyclohexyl)methyl]cyclohexane, 1,1-bis[4-(4-aminophenoxy)phenyl]-4-(phenylmethyl)cyclohexane, 1,1-bis[4-(4-aminophenoxy)phenyl]-4-[(4-methylphenyl)methyl]cyclohexane, 1,1-bis[4-(4-aminophenoxy)phenyl]-4-[(4-ethylphenyl)methyl]cyclohexane), 1,1-bis[4-(4-aminophenoxy)phenyl]-4-[(4-propylphenyl)methyl]cyclohexane, 1,1-bis[4-(4-aminophenoxy)phenyl]-4-[(4-butylphenyl)methyl]cyclohexane, 1,1-bis[4-(4-aminophenoxy)phenyl]-4-[(4-pentylphenyl)methyl]cyclohexane, 1,1-bis[4-(4-aminophenoxy)phenyl]-4-[(4-hexylphenyl)methyl]cyclohexane, 1,1-bis[4-(4-aminophenoxy)phenyl]-4-[(4-heptylphenyl)methyl]cyclohexane, 1,1-bis[4-(4-aminophenoxy)phenyl]-4-[(4-octylphenyl)methyl]cyclohexane, 1,1-bis(4-aminophenyl)-4-(phenyl methyl)cyclohexane, 1,1-bis(4-aminophenyl)-4-[(4-methylphenyl)methyl]cyclohexane, 1,1-bis(4-aminophenyl)-4-[(4-ethylphenyl)methyl]cyclohexane, 1,1-bis(4-aminophenyl)-4-[(4-propylphenyl)methyl]cyclohexane, 1,1-bis(4-aminophenyl)-4-[(4-butylphenyl)methyl]cyclohexane, 1,1-bis(4-aminophenyl)-4-[(4-pentylphenyl)methyl]cyclohexane, 1,1-bis(4-aminophenyl)-4-[(4-hexylphenyl)methyl]cyclohexane, 1,1-bis(4-aminophenyl)-4-[(4-heptylphenyl)methyl]cyclohexane, 1,1-bis(4-aminophenyl)-4-[(4-octylphenyl)methyl]cyclohexane, 1,1-bis[4-((4-aminophenyl)methyl)phenyl]-4-(phenylmethyl)cyclohexane, 1,1-bis[4-((4-aminophenyl)methyl)phenyl]-4-[(4-methylphenyl)methyl]cyclohexane), 1,1-bis[4-((4-aminophenyl)methyl)phenyl]-4-[(4-ethylphenyl)methyl]cyclohexane, 1,1-bis[4-((4-aminophenyl)methyl)phenyl]-4-[(4-propylphenyl)methyl]cyclohexane, 1,1-bis[4-((4-aminophenyl)methyl)phenyl]-4-[(4-butylphenyl)methyl]cyclohexane, 1,1-bis[4-((4-aminophenyl)methyl)phenyl]-4-[(4-pentylphenyl)methyl]cyclohexane, 1,1-bis[4-((4-aminophenyl)methyl)phenyl]-4-[(4-hexylphenyl)methyl]cyclohexane, 1,1-bis[4-((4-aminophenyl)methyl)phenyl]-4-[(4-heptylphenyl)methyl]cyclohexane, 1,1-bis[4-((4-aminophenyl)methyl)phenyl]-4-[(4-octylphenyl)methyl]cyclohexane, and mixtures thereof.

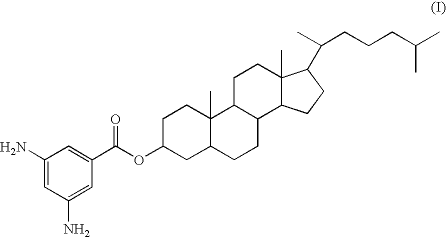

In an example of this invention, the aromatic diamine having a side chain of the polyamic acid B is the diamine having the formula (I).

The non-aromatic diamine of the polyamic acid B is selected from the group consisting of an aliphatic diamine, an alicyclic diamine, and the mixture thereof. In an example of this invention, the non-aromatic diamine is an alicyclic diamine.

The aliphatic diamine of the polyamic acid B can be any aliphatic diamine, and preferably, is selected from the group consisting of 1,4-diamino-1,1-dimethylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,6-diamino-2,5-dimethylhexane, 1,6-diamino-2,4-dimethylhexane, 1,6-diamino-3,3-dimethylhexane, 1,6-diamino-2,2-dimethylhexane, 1,6-diamino-2,2,4-trimethylhexane, 1,6-diamino-2,4,4-trimethylhexane, and mixtures thereof.

The alicyclic diamine of the polyamic acid B can be any alicyclic diamine, and preferably, is selected from the group consisting of 4,4′-diaminodicyclohexylmethane (HDAM), 1,4-diaminocyclohexane, 1,1-bis(4-aminocyclohexyl)propane, 2,2-bis(4-aminocyclohexyl)propane, 1,1-bis(4-aminocyclohexyl)ethane, 1,1-bis(4-aminocyclohexyl)butane, 2,2-bis(4-aminocyclohexyl)butane, 2-(4-aminocyclohexyl)-2-(4-amino-3-methylcyclohexyl)methane, 4-amino-3,5-dimethylcyclohexyl-4-amino-3-methylcyclohexylmethane, 4-aminocyclohexyl-4-amino-3-methylcyclohexylmethane, 2,2-bis(4-amino-3,5-dimethylcyclohexyl)butane, 2,2-bis(4-amino-3,5-dimethylcyclohexyl)propane, 1,1-bis(4-amino-3,5-dimethylcyclohexyl)ethane, 2,2-bis(4-amino-3-methylcyclohexyl)propane, 1,1-bis (4-amino-3-methylcyclohexyl)ethane, and mixtures thereof. In an example of this invention, the alicyclic diamine is HDAM.

In this invention, in addition to the aromatic tetracarboxylic dianhydride and the aromatic diamine, the polyamic acid A can further include other components, such as aliphatic tetracarboxylic dianhydride. Similarly, in addition to the aliphatic tetracarboxylic dianhydride, the aromatic diamine having a side chain, and the non-aromatic diamine, the polyamic acid B can further include other components, such as an aromatic diamine without a side chain.

The polyamic acid-based composition can be mixed with a solvent to form a mixture as a liquid crystal orienting agent for use in a subsequent process of preparing a liquid crystal orienting film. Preferably, the mixture has a solid content ranging from 4 to 20 wt %, more preferably, from 4 to 10 wt %.

As described above, the polyamic acid-based composition is obtained by mixing the polyamic acid A and the polyamic acid B. In an example of this invention, the polyamic acid A and the polyamic acid B are mixed with a solvent, respectively, to obtain a mixture A and a mixture B (both of them having the same concentration) followed by mixing the mixture A and the mixture B so as to obtain the polyamic acid-based composition according to this invention.

Preferably, the solvent is selected from the group consisting of N-methyl-2-pyrrolidinone (NMP), ethylene glycol monobutyl ether (BC), dimethylacetamide (DMAc), dimethylformamide (DMF), dimethylsulfoxide (DMSO), γ-butyrolactone, tetramethylurea, hexamethylphosphor triamide, m-cresol, xylenol, phenol, halogenated phenol chlorobenzene, dichloroethane, tetrachloroethane, cyclohexanone, and mixtures thereof. More preferably, the solvent is a mixture of NMP and BC at a weight ratio ranging from 90:10 to 60:40. In an example of this invention, the weight ratio of NMP to BC is 60:40.

The process for preparing the liquid crystal orienting film according to this invention includes: preparing a mixture containing the aforesaid polyamic acid-based composition and a solvent; coating the mixture onto a substrate so as to form a film on the substrate; and heating the film so as to convert polyamic acid of the polyamic acid-based composition of the film into polyamide.

Specifically, the liquid crystal orienting film of this invention is obtained by coating the aforesaid mixture onto a substrate so as to form a film on the substrate, and heating the film. During heating, the polyamic acid-based composition contained in the mixture undergoes dehydration and ring-closing processes, which result in conversion of polyamic acid into polyamide so that the liquid crystal orienting film of polyamide is formed on the substrate. The liquid crystal orienting film thus formed is normally pretreated, e.g., rubbed, before being assembled with a commercially available liquid crystal material so as to improve the orienting property, the pre-tilt angle, and the voltage holding ratio of the liquid crystal material.

### EXAMPLES

### Preparations of Polyamic Acids A and B

Polyamic acid Al was prepared by mixing 21.17 g HDAM (available from New Japan Chemical Co. Ltd., Japan) and 19.01 g BDA (available from New Japan Chemical Co. Ltd., Japan) with 206 g NMP, and stirring the mixture at 20° C. for 24 hours. A solvent containing NMP and BC (60:40) was added into polyamic acid A1 to adjust the solid content of the polyamic acid A1 to 8 wt %.

Polyamic acid A2 was prepared by mixing 8.75 g HDAM, 8.02 g BDA, 14.90 g BAPB (available from Wakayama Seika Kogyo Company, Japan), and 8.48 g PMDA (available from Wakayama Seika Kogyo Company, Japan) with 161 g NMP, and stirring the mixture at 20° C. for 24 hours. A solvent containing NMP and BC (60:40) was added into polyamic acid A2 to adjust the solid content of the polyamic acid A2 to 8 wt %.

Polyamic acid A3 was prepared by mixing 4.05 g HDAM, 3.71 g BDA, 20.70 g BAPB, and 11.94 g PMDA with 162 g NMP, and stirring the mixture at 20° C. for 24 hours. A solvent containing NMP and BC (60:40) was added into polyamic acid A3 to adjust the solid content of the polyamic acid A3 to 8 wt %.

Polyamic acid A4 was prepared by mixing 26.13 g BAPB and 13.93 g PMDA with 160 g NMP, and stirring the mixture at 20° C. for 24 hours. A solvent containing NMP and BC (60:40) was added into polyamic acid A4 to adjust the solid content of the polyamic acid A4 to 8 wt %.

Polyamic acid B1 was prepared by mixing 2.94 g of the compound of formula (I), 19.09 g HDAM, and 18.24 g BDA with 195 g NMP, and stirring the mixture at 20° C. for 24 hours. A solvent containing NMP and BC (60:40) was added into polyamic acid B1 to adjust the solid content of the polyamic acid B1 to 8 wt %. The compound of formula (I) was prepared by dissolving 3,5-dinitrobenzoyl chloride and cholesterol at a molar ratio of 1:1 in toluene so as to form a solution; adding 1 mole pyridine in the solution so as to form a mixture; reacting the mixture at 25° C. for 10 hours so as to obtain a product; purifying the product to obtain a dinitro-compound; and reducing the dinitro-compound so as to obtain the compound of formula (I).

The mole percentage for each of the reactants of the polyamic acids A1 to A4 and B1 is shown in Table 1.

TABLE 1

| | Mole percentage | | | | |
|---|---|---|---|---|---|
| | Aromatic diamine | | | | |
| | having a | | | | |
| | side | | | Aromatic | Aliphatic |
| | chain | Aromatic | Alicyclic | tetracarboxylic | tetracarboxylic |
| | Formula | diamine | diamine | dianhydride | dianhydride |
| Polyamic acid | (I) | BAPB | HDAM | PMDA | BDA |
| A1 | — | — | 100 | — | 100 |
| A2 | — | 50 | 50 | 50 | 50 |
| A3 | — | 75 | 25 | 75 | 25 |
| A4 | — | 100 | — | 100 | — |
| B1 | 6 | — | 94 | — | 100 |

### Preparations of Polyamic Acid-Based Compositions

### Example 1

250 g polyamic acid A4 and 250 g polyamic acid B1 were mixed and stirred at 20° C. for 6 hours so as to obtain the polyamic acid-based composition having 8 wt % solid content.

### Comparative Examples 1 to 5

The polyamic acid-based compositions employed for Comparative examples 1 to 5 were polyamic acid B1, A1, A2, A3, and A4, respectively.

### Comparative Example 6

The polyamic acid-based composition employed for Comparative example 6 was prepared by mixing 250 g polyamic acid B1 with 250 g polyamic acid A1, and stirring the mixture at 20° C. for 6 hours so as to obtain the polyamic acid-based composition having 8 wt % solid content for Comparative example 6.

### Preparation of Liquid Crystal Orienting Film

Liquid crystal orienting films were obtained by coating 3 g of each of the polyamic acid-based compositions of each of Example 1 and Comparative examples 1 to 6 on a 50 mm×50 mm substrate of indium tin oxide (ITO) using a spin coater at a speed of 4000 rpm/20 sec, preheating the substrate and the polyamic acid-based composition at 80° C. for 10 minutes, and curing the polyamic acid-based composition at 220° C. for 60 minutes to convert polyamic acid of the polyamic acid-based composition into polyamide so as to form the liquid crystal orienting film for each of Example 1 and Comparative Examples 1 to 6 on the substrate.

### Test for Pre-Tilt Angle

Two ITO substrates independently coated with the same liquid crystal orienting film thus formed were subjected to a rubbing process using a rubbing machine (ESR-1, available from E-SUN Precision Industrial Co., Ltd., pile impression: 0.5 mm, rubbing roller diameter: 170 mm (700 rpm), stage speed 100 mm/min, and the rubbing cloth used was YA-25). One of the ITO substrates coated with the liquid crystal orienting film was stacked in the following order with a first polyethylene terephthalate film (having a size of 50 mm in length, 5 mm in width, and 50 μm in thickness), a second polyethylene terephthalate film, and the other ITO substrate coated with the same liquid crystal orienting film so as to form a laminate. The two liquid crystal orienting films on the ITO substrates of the laminate were arranged in such a manner to face the first and second polyethylene terephthalate films, respectively. Then, a liquid crystal (DN-132131, available from Daily Polymer Corp., having a phase transition temperature of 90° C., and free of a dopant) was filled into a space between the first and second polyethylene terephthalate films. The laminate filled with the liquid crystal was applied with an adhesive (an epoxy resin AB glue available from Nan-Ya Plastics Co. was used in these examples) on a periphery thereof, followed by heating the same at 90° C. for 5 minutes so as to obtain testing samples. The pre-tilt angle of each of the testing samples was determined using a tilt bias angle measuring system (TBA 107™, available from Autronic Co., Germany). The results are shown in Table 2. It should be noted that the desired pre-tilt angle will be different for different liquid crystal materials.

### Preparation of a Sample for Voltage Holding Ratio (VHR) and Orienting Property Tests

Two ITO substrates independently coated with the same liquid crystal orienting film were subjected to a rubbing process as described above. One of the ITO substrates was coated with a seal (available from Mitsui Chemicals, Inc., Japan) on a periphery of the liquid crystal orienting film such that a 20 μm gap was formed. A plurality of spacers (available from Mitsui Chemicals, Inc., Japan, 6.75 μm diameter) were disposed on the other of the ITO substrates at a density of 150-200/cm² so that, upon lamination, the two ITO substrates were spaced apart from each other by the spacers so as to form a space therebetween. Then, the two ITO substrates were laminated together in such a manner that the two liquid crystal orienting films respectively formed on the ITO substrates faced each other and were spaced apart from each other by the spacers. A liquid crystal (XLC-2185, available from Daily Polymer Corp.) was filled into the space through the gap, followed by sealing the gap using an adhesive and curing the adhesive using ultraviolet light so as to form an assembly. The assembly was heated at 90° C. for 5 minutes so as to obtain a sample to be tested.

### Test for Voltage Holding Ratio (VHR)

Each sample to be tested was applied with a positive pulse voltage and a negative pulse voltage using a VHR measuring system (VHR-1A, available from Toyo corporation, Japan), with the sample being located at an open condition during the intervals between applications of the positive and negative pulse voltages. The positive and negative pulse voltages vs. time were recorded. The average area of the area of the positive pulse voltage multiplied by time and the area of the negative pulse voltage multiplied by time was referred as a VHR value. The results are shown in Table 2.

### Observation of Orienting Property

Undesired domains that occurred at the interface between the liquid crystal layer and the seal layer in each of the samples were observed using a polarizing microscope (Type 120, available from Nikon Company). The results are shown in Table 2.

TABLE 2

| | Component | | | |
|---|---|---|---|---|
| | of the | | | Occurrence |
| | polyamic | | | of the |
| | acid-based | Pre-tilt | | undesired |
| | composition | angle (°) | VHR (%) | domains |
| Example 1 | A4 + B1 | 7.6 | 99.4 | No |
| Comparative | B1 | 35.1 | 99.4 | Yes |
| example 1 | | | | |
| Comparative | A1 | 2.4 | 99.1 | No |
| example 2 | | | | |
| Comparative | A2 | 2.7 | 97.7 | No |
| example 3 | | | | |
| Comparative | A3 | 2.7 | 94.3 | No |
| example 4 | | | | |
| Comparative | A4 | 2.2 | 66.2 | No |
| example 5 | | | | |
| Comparative | A1 + B1 | 11 | 99.4 | Yes |
| example 6 | | | | |

As shown in Table 2, although Comparative examples 1 and 6 have good pre-tilt angle and/or VHR, undesired domains that adversely affect the orienting property occurred. In Comparative examples 2, 3, 4, and 5, in spite of no occurrence of undesired domains, pre-tilt angle and/or VHR do not meet industry requirements. However, Example 1 of this invention has a 7.6° pre-tilt angle and a 99.4% VHR, and undesired domains were not observed, which meets industry requirements.

### Effect of Mixing Ratio of the Polyamic Acid A to Polyamic Acid B Test

Polyamic acid-based compositions having 8 wt % solid content of Examples 1 to 12 were obtained by mixing polyamic acid B1 and polyamic acid A4 at different ratios shown in Table 3, and stirring the mixtures at 20° C. for 6 hours. Liquid crystal orienting films made from the polyamic acid-based compositions thus prepared were subjected to tests for pre-tilt angle, VHR, and orienting property. The results of the test are shown in Table 3.

TABLE 3

| | Mixing | | | Occurrence of |
|---|---|---|---|---|
| | ratio | Pre-tilt | | the undesired |
| Example | B1:A4 | angle (°) | VHR (%) | domains |
| 1 | 50:50 | 7.6 | 99.4 | No |
| 2 | 95:5 | 30 | 99.4 | No |
| 3 | 90:10 | 32.4 | 99.4 | No |
| 4 | 85:15 | 30.5 | 99.4 | No |
| 5 | 80:20 | 16 | 99.4 | No |
| 6 | 70:30 | 16.1 | 99.4 | No |
| 7 | 60:40 | 16.1 | 99.4 | No |
| 8 | 30:70 | 7.5 | 99 | No |
| 9 | 25:75 | 7.3 | 98 | No |
| 10 | 20:80 | 6.8 | 96 | No |
| 11 | 15:85 | 4.5 | 90 | No |
| 12 | 10:90 | 4.0 | 80 | No |

As shown in Table 3, when the mixing ratio ranges from 25:75 to 70:30, good properties (i.e., pre-tilt angle ranging between 7.3 to 16.1°, VHR ranging between 98 to 99.4%, and no undesired domains) are obtained. Specifically, 99% VHR is obtained when the mixing ratio ranges from 30:70 to 50:50. Although VHR is decreased in some examples, it can be compensated by replacing the liquid crystal material and adjusting processing conditions (e.g., curing temperature and time, and pile impression).

With the inclusion of the polyamic acid A made from an aromatic tetracarboxylic dianhydride and an aromatic diamine and the polyamic acid B made from an aliphatic tetracarboxylic dianhydride, an aromatic diamine having a side chain, and a non-aromatic diamine, the polyamic acid-based composition can not only provide a desired pre-tilt angle (7.3 to 16.1°) and VHR (higher than 99%) but also improve orienting property for the liquid crystal.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A polyamic acid-based composition comprising:
a polyamic acid A prepared by a process including reacting an aromatic tetracarboxylic dianhydride and an aromatic diamine; and
a polyamic acid B prepared by a process including reacting an aliphatic tetracarboxylic dianhydride, an aromatic diamine having a side chain, and a non-aromatic diamine.

2. The polyamic acid-based composition of claim 1, wherein the ratio of said polyamic acid A to said polyamic acid B ranges from 75:25 to 30:70.

3. The polyamic acid-based composition of claim 2, wherein the ratio of said polyamic acid A to said polyamic acid B ranges from 70:30 to 50:50.

4. The polyamic acid-based composition of claim 1, wherein the molar ratio of said aromatic diamine to said non-aromatic diamine of said polyamic acid B ranges from 70:30 to 1:99.

5. The polyamic acid-based composition of claim 4, wherein the molar ratio of said aromatic diamine having the side chain to said non-aromatic diamine of said polyamic acid B ranges from 45:55 to 3:97.

6. The polyamic acid-based composition of claim 5, wherein the molar ratio of said aromatic diamine having the side chain to said non-aromatic diamine of said polyamic acid B is 6:94.

7. The polyamic acid-based composition of claim 1, wherein said aromatic tetracarboxylic dianhydride of said polyamic acid A is selected from the group consisting of pyromellitic dianhydride, biphenyl tetracarboxylic dianhydride, 1,4,5,8-naphthalenetetracarboxylic dianhydride, 2,3,6,7-naphthalenetetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furanetetracarboxylic, dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, bis(phthalic acid) phenylphosphine oxide dianhydride, p-phenylene-bis(triphenylphthalic)dianhydride, m-phenylene-bis(triphenylphthalic)dianhydride, bis(triphenylphthalic acid)-4-4′-diphenylether dianhydride, bis(triphenylphthalic acid)-4-4′-diphenylmethane dianhydride, and mixtures thereof.

8. The polyamic acid-based composition of claim 7, wherein said aromatic tetracarboxylic dianhydride of said polyamic acid A is pyromellitic dianhydride.

9. The polyamic acid-based composition of claim 1, wherein said aromatic diamine of said polyamic acid A is selected from the group consisting of 2,2-bis[4-(4-aminophenoxy)phenyl]hexafluoropropane, 2,2-bis(4-aminophenoxy)hexafluoropropane, 2,2′-bis[4-(4-amino-2-trifluoromethylphenoxy)phenyl]hexafluoropropane, 4,4′-diamino-2,2′-bis(trifluoromethyl)biphenyl, 4,4′-bis[(4-amino-2-trifluoromethyl)phenoxy]octafluorobiphenyl, 4,4′-bis[(4-aminophenoxy)biphenyl, p-phenylenediamine, m-phenylenediamine, 4,4′-diamino-3,3′-dicarboxydiphenylmethane, 1,4-bis(4-aminophenyl)benzene, 4,4′-diaminophenyl, 3,3′-dimethyl-4,4′-diaminobiphenyl, 3,3′-dimethoxy-4,4′-diaminobiphenyl, 3,3′-dihydroxy-4,4′-diaminobiphenyl, 3,3′-dichloro-4,4′-diaminobiphenyl, 3,3′-diamino-4,4′-diaminobiphenyl, diaminodiphenylmethane, diaminodiphenyl ether, 2,2′-diaminodiphenylpropane, 4,4′-diaminodiphenylsulfone, diaminobenzophenone, 1,3-bis(4-aminophenoxy)benzene, 1,4-bis(4-aminophenoxy)benzene, 4,4′-di(aminophenoxy)diphenylsulfone, 2,2′-bis[4-(4-aminophenoxy)phenyl]propane, and mixtures thereof.

10. The polyamic acid-based composition of claim 9, wherein said aromatic diamine of said polyamic acid A is 4,4′-bis[(4-aminophenoxy)biphenyl.

11. The polyamic acid-based composition of claim 1, wherein said aliphatic tetracarboxylic dianhydride of said polyamic acid B is selected from the group consisting of bicyclo(2,2,2)oct-7-ene-2,3,5,6-tetracarboxylic dianhydride,1,2,3,4-butanetetracarboxylicdianhydride, 3,4-dicarboxy-1,2,3,4-tetrahydro-1-naphthalene succinicanhydride, 2,3,5-tricarboxycyclopentylacetic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 3,5,6-tricarboxynorbornane-2-acetic dianhydride, 2,3,4,5-tetrahydrofurantetracarboxylic dianhydride, and mixtures thereof.

12. The polyamic acid-based composition of claim 11, wherein said aliphatic tetracarboxylic dianhydride of said polyamic acid B is 1,2,3,4-butanetetracarboxylic dianhydride.

13. The polyamic acid-based composition of claim 1, wherein said aromatic diamine having the side chain of said polyamic acid B is selected from the group consisting of a diamine expressed by formula (I), 1,1-bis[4-(4-aminophenoxy)phenyl]-4-(cyclohexylmethyl)cyclohexane, 1,1-bis[4-(4-aminophenoxy)phenyl]-4-[(4-methylcyclohexyl)methyl]cyclohexane, 1,1-bis[4-(4-aminophenoxy)phenyl]-4-[(4-ethylcyclohexyl)methyl]cyclohexane, 1,1-bis[4-(4-aminophenoxy)phenyl]-4-[(4-propylcyclohexyl)methyl]cyclohexane, 1,1-bis[4-(4-aminophenoxy)phenyl]-4-[(4-butylcyclohexyl)methyl]cyclohexane, 1,1-bis[4-(4-aminophenoxy)phenyl]-4-[(4-pentylcyclohexyl)methyl]cyclohexane, 1,1-bis[4-(4-aminophenoxy)phenyl]-4-[(4-hexylcyclohexyl)methyl]cyclohexane, 1,1-bis[4-(4-aminophenoxy)phenyl]-4-[(4-heptylcyclohexyl)methyl]cyclohexane, 1,1-bis[4-(4-aminophenoxy)phenyl]-4-[(4-octylcyclohexyl)methyl]cyclohexane, 1,1-bis(4-aminophenyl)-4-(cyclohexylmethyl)cyclohexane, 1,1-bis(4-aminophenyl)-4-[(4-methylcyclohexyl)methyl]cyclohexane, 1,1-bis(4-aminophenyl)-4-[(4-ethylcyclohexyl)methyl]cyclohexane, 1,1-bis(4-aminophenyl)-4-[(4-propylcyclohexyl)methyl]cyclohexane, 1,1-bis(4-aminophenyl)-4-[(4-butylcyclohexyl)methyl]cyclohexane, 1,1-bis(4-aminophenyl)-4-[(4-pentylcyclohexyl)methyl]cyclohexane, 1,1-bis(4-aminophenyl)-4-[(4-hexylcyclohexyl)methyl]cyclohexane, 1,1-bis(4-aminophenyl)-4-[(4-heptylcyclohexyl)methyl]cyclohexane, 1,1-bis(4-aminophenyl)-4-[(4-octylcyclohexyl)methyl]cyclohexane, 1,1-bis[4-(4-aminophenoxy)phenyl]-4-(phenylmethyl)cyclohexane, 1,1-bis[4-(4-aminophenoxy)phenyl]-4-[(4-methylphenyl)methyl]cyclohexane, 1,1-bis[4-(4-aminophenoxy)phenyl]-4-[(4-ethylphenyl)methyl]cyclohexane), 1,1-bis[4-(4-aminophenoxy)phenyl]-4-[(4-propylphenyl)methyl]cyclohexane, 1,1-bis[4-(4-aminophenoxy)phenyl]-4-[(4-butylphenyl)methyl]cyclohexane, 1,1-bis[4-(4-aminophenoxy)phenyl]-4-[(4-pentylphenyl)methyl]cyclohexane, 1,1-bis(4-(4-aminophenoxy)phenyl]-4-[(4-hexylphenyl)methyl]cyclohexane, 1,1-bis[4-(4-aminophenoxy)phenyl]-4-[(4-heptylphenyl)methyl]cyclohexane, 1,1-bis[4-(4-aminophenoxy)phenyl]-4-[(4-octylphenyl)methyl]cyclohexane, 1,1-bis(4-aminophenyl)-4-(phenylmethyl)cyclohexane, 1,1-bis(4-aminophenyl)-4-[(4-methylphenyl)methyl]cyclohexane, 1,1-bis(4-aminophenyl)-4-[(4-ethylphenyl)methyl]cyclohexane, 1,1-bis(4-aminophenyl)-4-[(4-propylphenyl)methyl]cyclohexane, 1,1-bis(4-aminophenyl)-4-[(4-butylphenyl)methyl]cyclohexane, 1,1-bis(4-aminophenyl)-4-[(4-pentylphenyl)methyl]cyclohexane, 1,1-bis(4-aminophenyl)-4-[(4-hexylphenyl)methyl]cyclohexane, 1,1-bis(4-aminophenyl)-4-[(4-heptylphenyl)methyl]cyclohexane, 1,1-bis(4-aminophenyl)-4-[(4-octylphenyl)methyl]cyclohexane, 1,1-bis[4-((4-aminophenyl)methyl)phenyl]-4-(phenylmethyl)cyclohexane, 1,1-bis[4-((4-aminophenyl)methyl)phenyl]-4-[(4-methylphenyl)methyl]cyclohexane), 1,1-bis[4-((4-aminophenyl)methyl)phenyl]-4-[(4-ethylphenyl)methyl]cyclohexane, 1,1-bis[4-((4-aminophenyl)methyl)phenyl]-4-[(4-propylphenyl)methyl]cyclohexane, 1,1-bis[4-((4-aminophenyl)methyl)phenyl]-4-[(4-butylphenyl)methyl]cyclohexane, 1,1-bis[4-((4-aminophenyl)methyl)phenyl]-4-[(4-pentylphenyl)methyl]cyclohexane, 1,1-bis[4-((4-aminophenyl)methyl)phenyl]-4-[(4-hexylphenyl)methyl]cyclohexane, 1,1-bis[4-((4-aminophenyl)methyl)phenyl]-4-[(4-heptylphenyl)methyl]cyclohexane, 1,1-bis[4-((4-aminophenyl)methyl)phenyl]-4-[(4-octylphenyl)methyl]cyclohexane, and mixtures thereof.

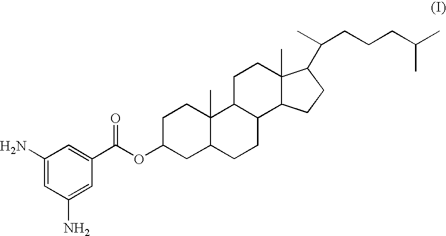

14. The polyamic acid-based composition of claim 13, wherein said aromatic diamine having the side chain of said polyamic acid B is the diamine expressed by formula (I).

15. The polyamic acid-based composition of claim 1, wherein said non-aromatic diamine of said polyamic acid B is selected from the group consisting of aliphatic diamine, alicyclic diamine, and the mixture thereof.

16. The polyamic acid-based composition of claim 15, wherein said non-aromatic diamine of said polyamic acid B is alicyclic diamine.

17. The polyamic acid-based composition of claim 16, wherein said alicyclic diamine is selected from the group consisting of 4,4′-diaminodicyclohexylmethane, 1,4-diaminocyclohexane, 1,1-bis(4-aminocyclohexyl)propane, 2,2-bis(4-aminocyclohexyl)propane, 1,1-bis(4-aminocyclohexyl)ethane, 1,1-bis(4-aminocyclohexyl)butane, 2,2-bis(4-aminocyclohexyl)butane, 2-(4-aminocyclohexyl)-2-(4-amino-3-methylcyclohexyl)methane, 4-amino-3,5-dimethylcyclohexyl-4-amino-3-methylcyclohexylmethane, 4-aminocyclohexyl-4-amino-3-methylcyclohexylmethane, 2,2-bis(4-amino-3,5-dimethylcyclohexyl)butane, 2,2-bis(4-amino-3,5-dimethylcyclohexyl)propane, 1,1-bis(4-amino-3,5-dimethylcyclohexyl)ethane, 2,2-bis(4-amino-3-methylcyclohexyl)propane, 1,1-bis (4-amino-3-methylcyclohexyl)ethane, and mixtures thereof.

18. The polyamic acid-based composition of claim 17, wherein said alicyclic diamine is 4,4′-diaminodicyclohexylmethane.

19. A liquid crystal orienting film formed by a process comprising: preparing a mixture containing the polyamic acid-based composition of claim 1 and a solvent; coating the mixture onto a substrate so as to form a film on the substrate; and heating the film so as to convert polyamic acid of the polyamic acid-based composition into polyamide.

20. The liquid crystal orienting film of claim 19, wherein said mixture of said polyamic acid-based composition of claim 1 and said solvent has a solid content ranging from 4 to 20 wt %.

21. The liquid crystal orienting film of claim 20, wherein said mixture of said polyamic acid-based composition of claim 1 and said solvent has a solid content ranging from 4 to 10 wt %.

22. The liquid crystal orienting film of claim 19, wherein said solvent is selected from the group consisting of N-methyl-2-pyrrolidinone, ethylene glycol monobutyl ether, dimethylacetamide, dimethylformamide, dimethylsulfoxide, γ-butyrolactone, tetramethylurea, hexamethylphosphor triamide, m-cresol, xylenol, phenol, halogenated phenol chlorobenzene, dichloroethane, tetrachloroethane, cyclohexanone, and mixtures thereof.

23. The liquid crystal orienting film of claim 22, wherein said solvent is a mixture of N-methyl-2-pyrrolidinone and ethylene glycol monobutyl ether.

24. The liquid crystal orienting film of claim 23, wherein the mixture of said solvent has a weight ratio of N-methyl-2-pyrrolidinone to ethylene glycol monobutyl ether ranging from 90:10 to 60:40.

25. The liquid crystal orienting film of claim 24, wherein the mixture of said solvent has a weight ratio of N-methyl-2-pyrrolidinone to ethylene glycol monobutyl ether that is 60:40.
